(19) United States
(12) Patent Application Publication
(10) Pub. No.: US 2003/0229548 A1
(43) Pub. Date: Dec. 11, 2003

(54) Cash home-delivery system and cash home-delivery method

(75) Inventor: Kazumasa Kakuta, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki, Japan

(21) Appl. No.: 10/465,547

(22) Filed: Jun. 20, 2003

Related U.S. Application Data
(63) Continuation of application No. PCT/JP00/09088, filed on Dec. 21, 2000.

(51) Int. Cl. G06F 17/60

(52) U.S. Cl. 705/26

(57) ABSTRACT

The present invention relates to a cash home-delivery system and a cash home-delivery method appropriate for cash home-delivery, including: an account manager that manages accounts; a cash home-delivery manager that receives a cash home-delivery request and orders a cash home-delivery if a condition of cash home-delivery is satisfied; a mobile settlement terminal that reads information recorded in a card associated with an account of a user and owned by the user, and accepts authentication information of the user input by an operation of the user, and then, sends a request for a settlement of the cash home-delivery to the account manager via a wireless communication line, and wherein, in response to the request for the settlement sent by the mobile settlement terminal, the account manager executes the settlement of the cash home-delivery by account transfer for transferring an amount of money required for the cash home-delivery.

### TECHNICAL FIELD

The present invention relates to a cash home-delivery system and cash home-delivery method appropriate for cash home-delivery.

### BACKGROUND ART

Transactions with banks, such as receiving cash etc., have been conventionally performed using automatic teller machines (ATMs) installed in banking offices and auto banks. However, since such banking offices and auto banks are found in business areas and near stations, they are not convenient for customers being in the distance. Also, an idea of receiving cash at stores such as convenient stores has been considered recently, yet even if it is realized that customers can receive cash at convenience stores etc., many customers still cannot get rid of inconvenience because there are few convenience stores in countryside and some seniors who cannot often go out. On the other hand, a system in which cash such as pensions etc. are paid by direct deposit through bank accounts or postal savings accounts has been already established.

In view of the above circumstances, based on the advent of an aging society, it is an object of the present invention to make it possible to receive cash at home.

### DISCLOSURE OF THE INVENTION

A cash home-delivery system of the present invention achieving the above object is characterized in that, the cash home-delivery system has: an account manager that manages accounts; a cash home-delivery manager that receives a request for a cash home-delivery and orders the cash home-delivery if a condition of cash home-delivery is satisfied; and a mobile settlement terminal that reads information recorded in a card associated with an account of a user and owned by the user, and accepts authentication information of the user input by an operation of the user, and then, sends a request for a settlement of the cash home-delivery to the account manager via a wireless communication line, and wherein, in response to the request for the settlement sent from the mobile settlement terminal, the account manager executes the settlement of the cash home-delivery by account transfer for transferring an amount of money required for the cash home-delivery.

Here, it is preferred that the cash home-delivery manager inquires of the account manager about information on the account of the user who requested the cash home-delivery, and then determines whether or not the condition of cash home-delivery for the user is satisfied based on a reply received from the account manager.

In the cash home-delivery system of the present invention, it is acceptable that cash to be delivered to the user is owned by a courier that delivers the cash, and the account manager transfers, in response to the request for the settlement sent from the mobile settlement terminal, an amount of money required for the cash home-delivery from an account of the user receiving the cash to an account of the courier that delivered the cash. Or it is acceptable that the cash to be delivered to the user is deposited in the courier by the financial institution, and the account manager transfers, in response to the request for the settlement sent from the mobile settlement terminal, an amount of money required for the cash home-delivery from the account of the user receiving the cash to an account of the financial institution, as well as transfers a delivery charge required for the cash home-delivery from the account of the financial institution to the account of the courier.

Also, a cash home-delivery method of the present invention achieving the above object is characterized in that, the cash home-delivery method has: a step in which a cash home-delivery manager that receives a cash home-delivery and sends an order the cash home-delivery if a condition of cash home-delivery is satisfied, receives the cash home-delivery to determine whether or not the condition of cash home-delivery is satisfied and sends an order for the cash home-delivery if the condition of cash home-delivery is satisfied; a step in which, in response to the order of the cash home-delivery, cash for home-delivery is delivered by carrying a mobile settlement terminal that reads information recorded in a card associated with an account of a user and owned by the user, accepts authentication information of the user input by an operation of the user, and sends a request for a settlement of the cash home-delivery to the account manager via a wireless communication line; a step in which the mobile settlement terminal reads information recorded in a card of the user who received the cash home-delivery, accepts authentication information of the user according to the operation of the user, and sends a request for a settlement of the cash home-delivery to an account manager that manages accounts via a wireless communication line; and a step in which, in response to the request for the settlement sent from the mobile settlement terminal, the account manager executes the settlement of the cash home-delivery by account transfer for transferring an amount of money required for the cash home-delivery.

Here, in the cash home-delivery method of the present invention described above, it is preferred that, for carrying out determination as to whether or not the condition of cash home-delivery is satisfied, the cash home-delivery manager inquires of the account manager about information on the account of the user who requested the cash home-delivery, and then carries out the determination based on a reply received from the account manager.

Further, in the cash home-delivery method of the present invention described above, it is acceptable that, cash to be delivered to the user is owned by a courier that delivers the cash, and the account manager transfers, in response to the request for the settlement sent by the mobile settlement terminal, an amount of money required for the cash home-delivery from an account of the user receiving the cash to an account of the courier that delivered the cash. Or it is acceptable that the cash to be delivered to the user is deposited in the courier that delivers the cash by the financial institution, and the account manager transfers, in response to the request for the settlement sent by the mobile settlement terminal, an amount of money required for the cash home-delivery from the account of the user receiving the cash to an account of the financial institution, as well as transfers a delivery charge required for the cash home-delivery from the account of the financial institution to the account of the courier.

According to the present invention as described above, it is possible to receive cash at home.

### BRIEF DESCRIPTION OF THE DRAWINGS

FIG. 1 is a typical illustration that illustrates an embodiment of a cash home-delivery method according to the present invention, adopting an embodiment of a cash home-delivery system of the present invention.

FIG. 2 is a typical illustration showing a cash flow when a financial institution mainly controls a business.

FIG. 3 is a typical illustration showing a cash flow when a carrier mainly controls a business.

### BEST MODE FOR CARRYING OUT THE INVENTION

Embodiments of the present invention will be described below.

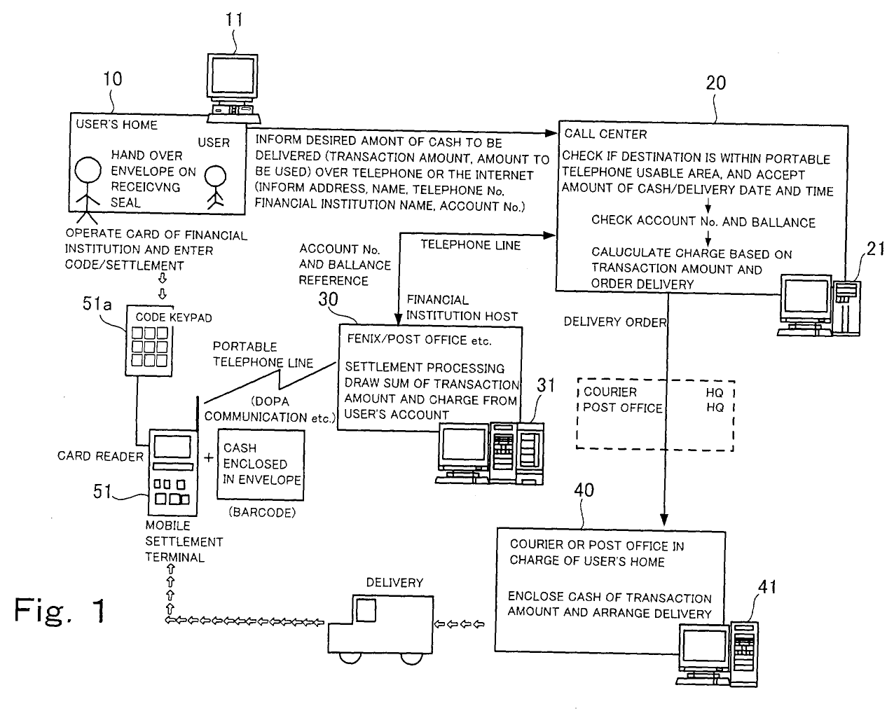

FIG. 1 is a typical illustration that illustrates an embodiment of a cash home-delivery method according to the present invention, adopting an embodiment of a cash home-delivery system of the present invention.

A user utilizing a cash home-delivery service requests a call center 20 to deliver cash by telephone or using a personal computer 11 of the user over the Internet, from a user's home 10. If a financial institution mainly controls this service, the call center 20 is a center to which the financial institution entrusts management of receiving requests for cash home-deliveries. If a carrier mainly controls this service, the call center 20 is a center to which the carrier entrusts management of receiving requests for cash home-deliveries, in order for the carrier to carry out “cash home-delivery service” in cooperation with a financial institution. Depending on who mainly controls this service, a fund reservoir for cash to be delivered to users and a flow of cash drawn from accounts of users are different, which will be described later.

When the user requests the call center to provide this service, the user tells the center about a desired address to which cash is delivered, such as his/her home address.

Then, the call center 20 first checks if the user's address is within a portable telephone usable area in which a mobile settlement terminal 51 (an example of the mobile settlement terminal of the present invention) necessary for a settlement can operate by operating a terminal 21 (an example of the cash home-delivery manager of the present invention) of the call center 20, or automatically checks it if the user requests the call center to provide this service over the Internet. If the user's address is within the portable telephone usable area, the process proceeds to the next step, however, the user is informed that this service is not available if the user's address is out of the portable telephone usable area.

If the user's address is within the portable telephone usable area, the call center 20 asks the user about a name of a bank branch or a post office utilized by the user, an account No., an amount of money to be delivered, a telephone No., a desired delivery date/time, etc. The call center 20 may accept delivering clean bills or specific denominations as the user desires.

When receiving the request given by the user as described above is finished, the call center 20 communicates with a host system 31 (an example of the account manager of the present invention) of a financial institution 30 via a communication line, and checks if the account No. informed by the user has the user's own name and if its balance is enough to cover the amount of money that the user requested to deliver, and then, if the checking was satisfactory, the call center 20 notifies the user of a receipt No. for a transaction in this service.

At this point, in order to prevent a transaction failure due to a shortfall in the balance in a settlement which is executed when the cash is delivered, credit transfers, payments, etc. via ATMs may be prohibited before this service is executed, by making a flag for temporarily freezing the user's account be on in the host system 31 when the request for this service is received.

Receiving requests for this service by the call center 20 can be automatic receipt using an answering-phone system, besides automatic receipt over the Internet and manned receipt. For receipt using the answering-phone system, it is preferred that the initial request is received and necessary items except for a desired amount of cash to be delivered, a desired delivery date/time, etc. which are different for every service are recorded beforehand through the manned receipt, so that subsequent bookings using the answering-phone system become easy.

If the user requests a cash home-delivery by the Internet or answering-phone system, a charge may be discounted to be less than that of the manned receipt over the telephone.

The call center 20, using the terminal 21 of the call center 20, orders a terminal 41 in a branch of the carrier or in a post office 40 in charge of the user's address to deliver an amount of cash the user specified, via a headquarters of the branch or post office, or directly. When ordering, the call center 20 informs the branch or post office 40 about a charge for this service, and the desired amount of cash to be delivered, delivery destination, desired delivery date/time, and receipt No. Here, if the financial institution mainly controls this service, it is supposed that the carrier is entrusted by the financial institution with providing this service, or the post office is entrusted by a transaction division of a post-office savings bank of the Ministry of Posts and Telecommunications with providing this service.

Upon receiving the order of cash home-delivery, the branch of the carrier or post office 40 encloses the specified amount of cash in an envelope. If the financial institution mainly controls this service, the fund is under the control of the financial institution. On the contrary, if a courier mainly controls this service, the fund is under the control of the courier. To this envelope, a barcode indicating the amount of drawn cash (the amount of cash enclosed), charge and receipt No. for this service (transaction) is affixed.

A deliveryman brings the envelope containing the cash together with the mobile settlement terminal 51 to the user's home 10 or the like. On arrival at the user's home or the like, the deliveryman starts the transaction by reading the barcode on the envelope using the mobile settlement terminal 51. At the same time, the deliveryman asks the user for the receipt No. for this service (transaction), and enters the receipt No. using a keyboard of the mobile settlement terminal 51 to make sure if the user and the person who requested the delivery are identical. If they are surely identical, the deliveryman notifies a settlement amount displayed on the mobile settlement terminal 51, and asks the user to carry out reading a cash card or a debit card of the user as well as to enter a code No. using a code keypad 51a of the mobile settlement terminal 51.

When the user makes sure of the settlement amount, and then, carries out reading the cash card or debit card and enters the code No., the mobile settlement terminal 51 communicates with a host computer 31 and sends a request for executing a settlement processing for the settlement amount specified.

The host computer of the financial institution executes the settlement processing upon receipt of the request for executing the settlement processing, and notifies the mobile settlement terminal 51 about a result of the settlement processing.

When the mobile settlement terminal 51 receives a notification about successful termination of the settlement by the host computer 31 of the financial institution, the deliveryman hands over the envelope to the user.

If the settlement fails due to a shortfall in the balance, a wrong account No. or a wrong code No., etc., the delivery man does not give the envelope to the user and brings it back. Here, the deliveryman handles the cash being always enclosed in the envelope so that the deliveryman does not need to directly touch the cash, which prevents an accident etc.

This service performs home-delivery of cash in the above-described procedure, but considering safety, it is preferred to predetermine a maximum amount of cash to be delivered, about for example 100 to 300 thousand yen.

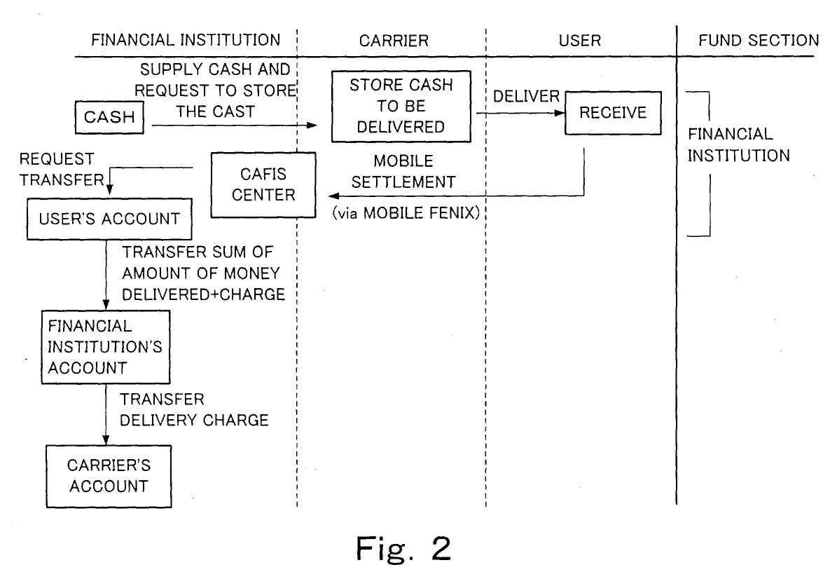

FIG. 2 is a typical illustration showing a cash flow when a financial institution mainly controls a business.

In this case, the financial institution supplies cash to a carrier and requests the carrier to store the cash. The carrier stores the cash of the financial institution, delivers the cash to a user as described above in response to a request of the user for using this service, and carries out a settlement using a mobile settlement terminal. In this settlement, through a CAFIS center as an authentication/settlement contracting institution, a host computer of the financial institution transfers the sum of an amount of money equal to the delivered cash and a charge, from an account of the user to an account of the financial institution, and further, a delivery charge is transferred from the account of the financial institution to an account of the carrier.

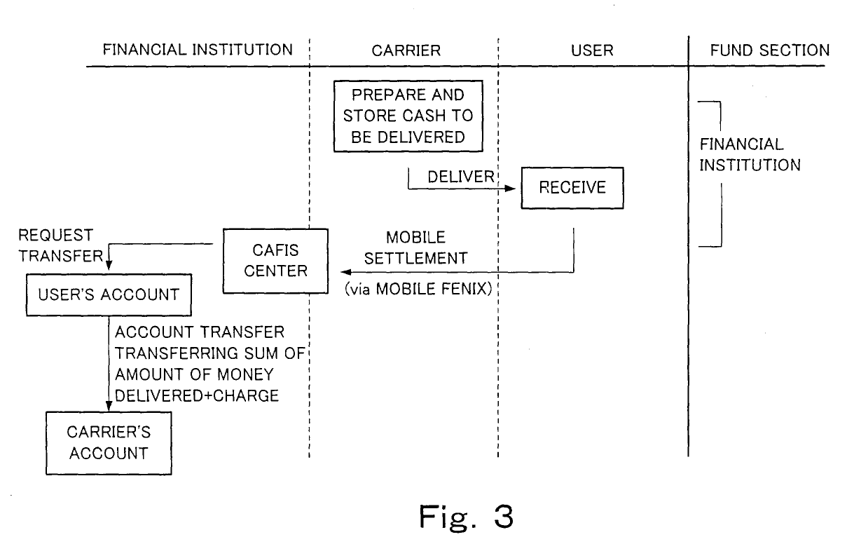

FIG. 3 is a typical illustration showing a cash flow when a carrier mainly controls a business.

In this case, the carrier prepares and stores own cash as cash to be delivered, and then, in response to a request from a user for using this service, the carrier delivers the cash to hand over it to the user and carries out a settlement using a mobile settlement terminal, as described above referring to FIG. 1. In this settlement, through a CAFIS center as an authentication/settlement contracting institution, a host computer of a financial institution transfers the sum of an amount of money equal to the delivered cash and a charge, from an account of the user to an account of the carrier.

Either of the settlements described referring to FIG. 2 and 3 is carried out depending on who controls the business in the service described referring to FIG. 1, a financial institution or a carrier, and accordingly, the service described referring to FIG. 1 can be realized whichever controls the business.

1. A cash home-delivery system characterized by comprising:
an account manager that manages accounts;
a cash home-delivery manager that receives a request for a cash home-delivery and orders the cash home-delivery if a condition of cash home-delivery is satisfied; and
a mobile settlement terminal that reads information recorded in a card associated with an account of a user and owned by the user, and accepts authentication information of the user input by an operation of the user, and then, sends a request for a settlement of the cash home-delivery to the account manager via a wireless communication line,
wherein, in response to the request for the settlement sent from the mobile settlement terminal, the account manager executes the settlement of the cash home-delivery by account transfer for transferring an amount of money required for the cash home-delivery.

2. A cash home-delivery system according to claim 1, characterized in that the cash home-delivery manager inquires of the account manager about information on the account of the user who requested the cash home-delivery, and then determines whether or not the condition of cash home-delivery for the user is satisfied based on a reply received from the account manager.

3. A cash home-delivery system according to claim 1, characterized in that cash to be delivered to the user is owned by a courier that delivers the cash, and the account manager transfers, in response to the request for the settlement sent from the mobile settlement terminal, an amount of money required for the cash home-delivery from an account of the user receiving the cash to an account of the courier that delivered the cash.

4. A cash home-delivery system according to claim 1, characterized in that cash to be delivered to the user is deposited in a courier by a financial institution, and the account manager transfers, in response to the request for the settlement sent from the mobile settlement terminal, an amount of money required for the cash home-delivery from an account of the user receiving the cash to an account of the financial institution, as well as transfers a delivery charge required for the cash home-delivery from the account of the financial institution to an account of the courier.

5. A cash home-delivery method characterized by comprising:
a step in which a cash home-delivery manager that receives a cash home-delivery and orders the cash home-delivery if a condition of cash home-delivery is satisfied, receives the cash home-delivery to determine whether or not the condition of cash home-delivery is satisfied and sends an order for the cash home-delivery if the condition of cash home-delivery is satisfied;
a step in which, in response to the order of the cash home-delivery, cash for the cash home-delivery is delivered by carrying a mobile settlement terminal that reads information recorded in a card associated with an account of a user and owned by the user, accepts authentication information of the user input by an operation of the user, and sends a request for a settlement of the cash home-delivery to the account manager via a wireless communication line;
a step in which the mobile settlement terminal reads information recorded in a card of a user who received the cash home-delivery, accepts authentication information of the user according to an operation of the user, and sends a request for a settlement of the cash home-delivery to the account manager that manages accounts via the wireless communication line; and
a step in which, in response to the request for the settlement sent from the mobile settlement terminal, the account manager executes the settlement of the cash home-delivery by account transfer for transferring an amount of money required for the cash home-delivery.

6. A cash home-delivery method according to claim 5, characterized in that, for carrying out a determination as to whether or not the condition of cash home-delivery is satisfied, the cash home-delivery manager inquires of the account manager about information on the account of the user who requested the cash home-delivery, and then carries out the determination based on a reply received from the account manager.

7. A cash home-delivery method according to claim 5, characterized in that cash to be delivered to the user is owned by a courier that delivers the cash, and the account manager transfers, in response to the request for the settlement sent from the mobile settlement terminal, an amount of money required for the cash home-delivery from an account of the user receiving the cash to an account of the courier that delivered the cash.

8. A cash home-delivery method according to claim 5, characterized in that cash to be delivered to the user is deposited in a courier by a financial institution, and the account manager transfers, in response to the request for the settlement sent from the mobile settlement terminal, an amount of money required for the cash home-delivery from an account of the user receiving the cash to an account of the financial institution, as well as transfers a delivery charge required for the cash home-delivery from the account of the financial institution to an account of the courier.
